(19) United States
(12) Patent Application Publication
(10) Pub. No.: US 2025/0244900 A1
(43) Pub. Date: Jul. 31, 2025

(54) METHOD FOR DATA DEDUPLICATION OF STORAGE APPARATUS AND STORAGE APPARATUS

(71) Applicant: Samsung Electronics Co., Ltd., Suwon-si (KR)

(72) Inventors: Kun ZHANG, Xi'an (CN); Hao YAN, Xi'an (CN)

(73) Assignee: Samsung Electronics Co., Ltd., Suwon-si (KR)

(21) Appl. No.: 18/644,641

(22) Filed: Apr. 24, 2024

(30) Foreign Application Priority Data
Jan. 26, 2024 (CN) 202410116248.8

(51) Int. Cl. G06F 3/06; G06F 16/215

(52) U.S. Cl. CPC G06F 3/0641; G06F 3/0613; G06F 3/0673; G06F 16/215

(57) ABSTRACT

A method for data deduplication of a storage apparatus and the storage apparatus are provided. In particular, a method for data deduplication of a storage apparatus, wherein the storage apparatus comprises a storage class memory (SCM) and a flash memory, the method comprising: obtaining a search result of searching for a fingerprint in fingerprint data stored in the SCM the fingerprint generated based on written data; and writing the written data to the flash memory in the case that the search result is the fingerprint generated based on the written data is not present in the fingerprint data.

### CROSS-REFERENCE TO RELATED APPLICATION

This application is based on and claims priority under 35 U.S.C. § 119 to Chinese Patent Application No. 202410116248.8, filed on Jan. 26, 2024, in the Chinese National Intellectual Property Administration, the disclosure of which is incorporated by reference herein in its entirety.

### TECHNICAL FIELD

The disclosure relates to the technical field of storage, and more particularly, to a method for data deduplication of a storage apparatus and the storage apparatus.

### BACKGROUND

Duplicate data leads to wasted storage resources, rapidly rising storage costs and/or also occupies data transfer bandwidth, which may require data deduplication techniques. The problems with data deduplication may be: fingerprint computation introduces significant CPU computation overhead; fingerprint storage introduces significant dynamic random access memory DRAM overhead; when considering the use of flash memory in conjunction with the DRAM for storing fingerprint data, only some of the fingerprint data frequently accessed is cached in the DRAM, and the overhead of loading the fingerprint data from the flash memory is high when the cache is not hit; and the data deduplication may have a negative impact on normal data reads and writes.

### SUMMARY

The disclosure provides a method for data deduplication of a storage apparatus and the storage apparatus to address a part of or all the problems described above.

According to an aspect of the disclosure, a method for data deduplication of a storage apparatus is provided, wherein the storage apparatus comprises a storage class memory (SCM) and a flash memory, the method comprising: obtaining a search result of searching for a fingerprint in fingerprint data stored in the SCM, the fingerprint being generated based on written data, and the written data being input data received by the storage apparatus; and writing the written data to the flash memory based on the obtained search result indicating that the fingerprint is not present in the fingerprint data.

Alternatively, the method further comprises sampling a controller workload and a data duplication rate; wherein a search result of searching for the fingerprint generated based on the written data is obtained based on the sampled controller workload being less than a first threshold and the sampled data duplication rate being greater than a preset data duplication rate.

Alternatively, the sampling of the data duplication rate comprises: selecting, randomly, a number of pages of data in a write cache; generating a corresponding number of fingerprints based on the number of randomly selected pages of data; obtaining search results of searching for the corresponding number of fingerprints based on the number of randomly selected pages of data in the fingerprint data stored in the SCM; and calculating the data duplication rate based on the search results of the corresponding number of the fingerprints.

Alternatively, the preset data duplication rate is calculated as a ratio between a sum of time to generate the fingerprint generated based on the written data and time to search for the fingerprint generated based on the written data and time to program data into the flash memory.

Alternatively, the storage apparatus further comprises a sampling module configured to sample the controller workload and the data duplication rate.

Alternatively, the method further comprises: writing the fingerprint generated based on the written data into the fingerprint data based on the search result indicating that the fingerprint generated based on the written data is not present in the fingerprint data.

Alternatively, the method further comprises: inserting mapping information of a logical address to a physical address into a logical-physical (L2P) mapping table, wherein the physical address is an address of the written data in the flash memory based on the search result indicating that the fingerprint generated based on the written data is not present in the fingerprint data, wherein the physical address is an address of a first data already stored in the flash based on the search result indicating that the fingerprint generated based on the written data is present in the fingerprint data, and the first data having the same fingerprint as the written data.

Alternatively, the method further comprises: inserting reverse mapping information of the physical address to the logical address into a reverse mapping table, wherein the reverse mapping table is stored in the SCM.

Alternatively, the storage apparatus further comprises a hardware acceleration module, the method further comprising: generating, by the hardware acceleration module, the fingerprint generated based on the written data; and searching, by the hardware acceleration module, for the fingerprint generated based on the written data in the fingerprint data stored in the SCM.

According to another aspect of the disclosure, a storage apparatus is provided, wherein the storage apparatus comprises a controller, a storage class memory (SCM) and a flash memory; the SCM including fingerprint data; wherein the controller is configured to: obtain a search result of searching for a fingerprint in the fingerprint data in the SCM, the fingerprint being generated based on written data, and the written data being input data received by the storage apparatus; and write the written data to the flash memory based on the obtained search result indicating that the fingerprint generated based on the written data is not present in the fingerprint data.

Alternatively, the storage apparatus further comprises a sampling module, configured to sample a controller workload and to sample a data duplication rate; wherein, the controller is configured to obtain the search result of searching for the fingerprint generated based on the written data in the fingerprint data, based on the sampled controller workload being less than a first threshold and the sampled data duplication rate being greater than a preset data duplication rate.

Alternatively, the sampling of the data duplication rate comprises: selecting, randomly, a number of pages of data in a write cache; generating a corresponding number of fingerprints based on the number of randomly selected pages of data; obtaining search results of searching for the corresponding number of fingerprints based on the number of randomly selected pages of data in the fingerprint data; and calculating the data duplication rate based on the search results of the corresponding number of the fingerprints.

Alternatively, the preset data duplication rate is calculated based on a ratio between a sum of time to generate the fingerprint generated based on the written data and time to search for the fingerprint generated based on the written data and time to program data into the flash memory.

Alternatively, the SCM is further configured to store the fingerprint data comprising the fingerprint generated based on the written data in the case that the search result indicating that the fingerprint generated based on the written data is not present in the fingerprint data.

Alternatively, the controller is further configured to: control insertion of mapping information of a logical address to a physical address into a logical-physical (L2P) mapping table, wherein the physical address is an address of the written data in the flash memory based on the search result indicating that the fingerprint generated based on the written data is not present in the fingerprint data, wherein the physical address is an address of a first data already stored in the flash memory based on the search result indicating that the fingerprint generated based on the written data is present in the fingerprint data, wherein the first data having the same fingerprint as the written data.

Alternatively, the SCM is further configured to store a reverse mapping table, wherein the controller is further configured to: control insertion of the reverse mapping information of the physical address to the logical address into the reverse mapping table.

Alternatively, the storage apparatus further comprises a hardware acceleration module, wherein the hardware acceleration module is configured to: generate the fingerprint generated based on the written data; and search for the fingerprint generated based on the written data in the fingerprint data.

According to another aspect of the disclosure, a system to which a storage apparatus is applied is provided, the system includes a main processor; a main memory; and the storage apparatus; the storage apparatus being configured to perform the method for data deduplication of the storage apparatus, the method comprising: obtaining a search result of searching for a fingerprint in fingerprint data stored in a storage class memory (SCM) in the storage apparatus, the fingerprint being generated based on written data, and the written data being input data received by the storage apparatus; and writing the written data to a flash memory in the storage apparatus based on the obtained search result indicating that the fingerprint generated based on the written data is not present in the fingerprint data.

Alternatively, the method further comprising: sampling a controller workload and a data duplication rate, wherein the search result of searching for the fingerprint generated based on the written data is obtained based on the sampled controller workload being less than a first threshold and the sampled data duplication rate being greater than a preset data duplication rate.

Alternatively, the storage apparatus comprises a hardware acceleration module, wherein the method further comprising: generating, by the hardware acceleration module, the fingerprint generated based on the written data; and searching, by the hardware acceleration module, for the fingerprint generated based on the written data in the fingerprint data stored in the SCM.

The technical solutions provided according to example embodiments of the disclosure bring at least the following effects: the introduction of the SCM for storing the fingerprint data enables better read and write performance while avoiding additional overhead to the DRAM, and the SCM is relatively inexpensive. The introduction of the hardware acceleration module to take on the computational tasks of the data deduplication procedure avoids the computational overhead to the main control chip. The sampling module is used to sample the controller workload and the data duplication rate, and the deduplication mechanism is enabled only when the sampled controller workload is relatively low and/or the data duplication rate is relatively high, thus improving or maximizing the benefits of the data deduplication. The reverse mapping table is used to store mappings of a single physical address to a plurality of logical addresses, and this reverse mapping table is stored in the SCM, which avoids the need to frequently update the flash memory during the data deduplication procedure and improves efficiency of the data deduplication.

It should be understood that the above general description and the later detailed description are examples and explanatory only and do not limit the disclosure.

### BRIEF DESCRIPTION OF THE DRAWINGS

The accompanying drawings herein are incorporated into and form part of the specification, illustrate example embodiments consistent with the disclosure, which are used in conjunction with the specification to explain the principles of the disclosure and do not constitute an undue limitation of the disclosure.

FIG. 1 illustrates an example of internal deduplication architecture of a storage apparatus.

FIG. 2 illustrates an example of CIDR deduplication architecture.

FIG. 3 illustrates an example of CAFTL deduplication architecture.

FIG. 4 illustrates an example of SmartDedup two-stage fingerprint storage architecture.

FIG. 5 illustrates an example of fingerprint computation overhead of data deduplication.

FIG. 6 illustrates an impact of an example of data deduplication on SSD performance.

FIG. 7 illustrates a block diagram of an example of data deduplication method.

FIG. 8 illustrates a block diagram of internal modules of a storage apparatus according to example embodiments.

FIG. 9 illustrates a flowchart of a method for data deduplication of a storage apparatus according to example embodiments.

FIG. 10 illustrates a comparison of different storage apparatuses according to example embodiments.

FIG. 11 illustrates overhead of different processors generating fingerprints according to example embodiments.

FIG. 12 illustrates a flowchart of a data deduplication strategy according to example embodiments.

FIG. 13 illustrates a schematic diagram of function of a reverse mapping table according to example embodiments.

FIG. 14 illustrates a flowchart of processing of writing non-duplicate data X according to example embodiments.

FIG. 15 illustrates a flowchart of processing of writing non-duplicate data Y according to example embodiments.

FIG. 16 illustrates a flowchart of processing of writing duplicate data Y according to example embodiments.

FIG. 17 illustrates a schematic diagram of a storage apparatus according to example embodiments.

FIG. 18 is a diagram of a system 1000 to which a storage device is applied, according to example embodiments.

FIG. 19 is a block diagram of a host storage system 10 according to example embodiments.

FIG. 20 is a diagram of a data center 3000 to which a memory device is applied, according to example embodiments.

### DETAILED DESCRIPTION

In order to enable a person of ordinary skill in the art to better understand the technical solutions of the disclosure, the technical solutions provide by example embodiments of the disclosure will be clearly and completely described below in conjunction with the accompanying drawings.

It should be noted that the terms “first”, “second”, etc. in the specification and claims of the disclosure and the accompanying drawings above are used to distinguish similar objects rather than to describe a particular order or sequence. It should be understood that data so distinguished may be interchanged, where appropriate, so that example embodiments of the disclosure described herein may be implemented in an order other than those illustrated or described herein. Example embodiments described in the following examples do not represent all example embodiments that are consistent with the disclosure. Rather, they are only examples of devices and methods that are consistent with some aspects of the disclosure, as detailed in the appended claims.

It should be noted herein that “at least one of the several items” in this disclosure includes “any one of the several items”, “any combination of the several items” and “all of the several items” the juxtaposition of these three categories. For example, “including at least one of A and B” includes the following three juxtapositions: (1) including A; (2) including B; (3) including A and B. Another example is “performing at least one of operation one and operation two”, which means the following three juxtapositions (1) performing operation one; (2) performing operation two; (3) performing operation one and operation two.

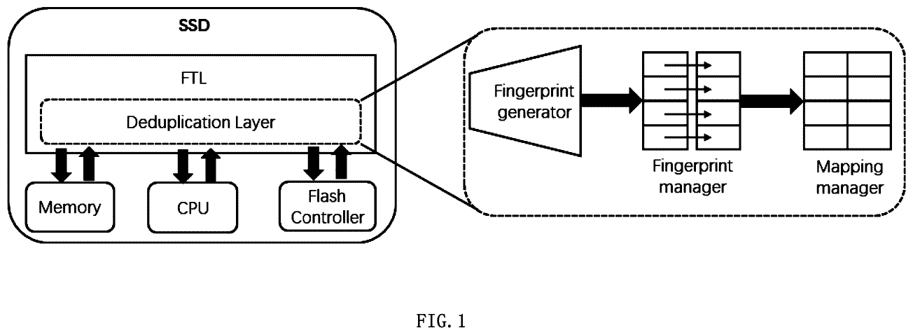

FIG. 1 illustrates an example of internal deduplication architecture of a storage apparatus. In order to facilitate the illustration of a deduplication layer in FIG. 1, firstly, terms related to the field of data deduplication are introduced. Fingerprint: a hash value, for example, is calculated for each data page, where the hash value is the fingerprint. For example, the data page may be a 4K data page. Fingerprint generation: in order to avoid collision of fingerprints, a hash algorithm with a low probability of collision needs to be used, SHA-1 (Secure Hash Algorithm1) may be used in the field of the data deduplication, which generates a 160-bit hash value for every 4K data, and the procedure of fingerprint generation brings significant computational overhead. Fingerprint storage: fingerprint data that has been computed is stored, either in a dynamic random access memory (DRAM) or a flash memory (flash). Fingerprint management: in order to improve the efficiency of fingerprint search, the stored fingerprints need to be managed in a certain data structure, for example, in a form of a hash table. Referencing to FIG. 1, FTL (Flash Translation Layer) of a storage apparatus (e.g. SSD) includes a deduplication layer, in which three modules are included: a fingerprint generator, a fingerprint manager and a mapping manager. The fingerprint generator is used to generate fingerprints, the fingerprint manager operates on the generated fingerprints and performs fingerprint searches to detect duplicate data, and further, the mapping manager handles the physical addresses of the duplicate data.

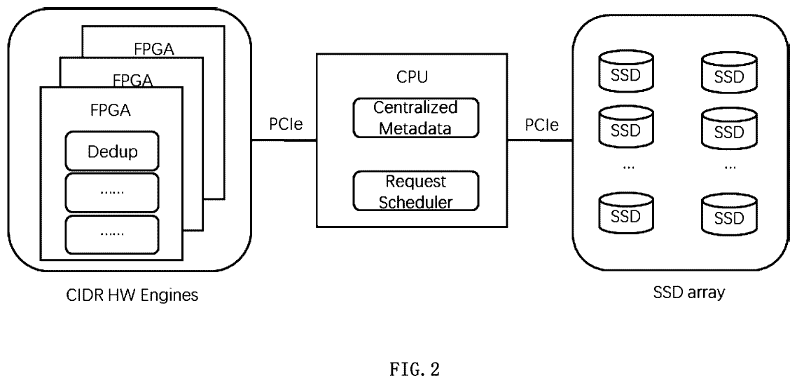

FIG. 2 illustrates an example of CIDR deduplication architecture. An array of FPGA hardware accelerators are deployed in the CIDR (Classless Inter-Domain Routing) deduplication architecture to distribute computational tasks associated with data deduplication to the FPGAs for execution.

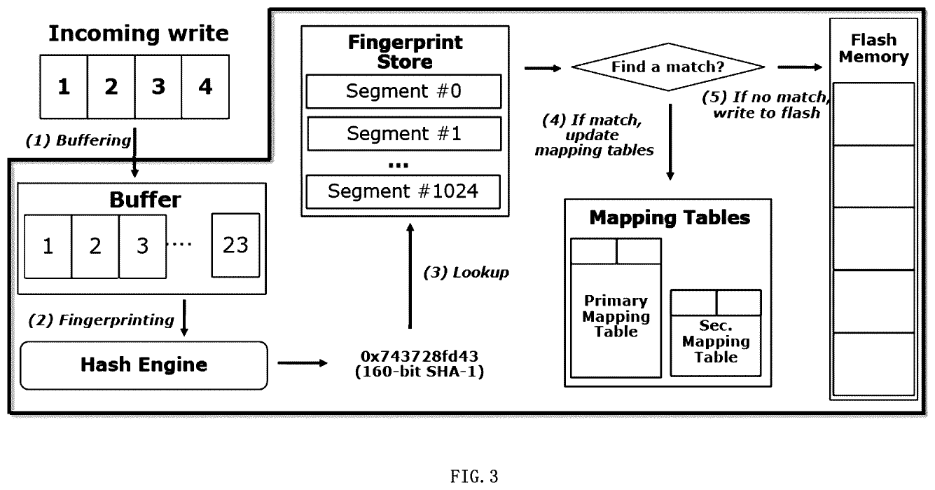

FIG. 3 illustrates an example of CAFTL deduplication architecture. The CAFTL (Content-Aware Flash Translation Layer) deduplication architecture extends life of an SSD by eliminating duplicate writes and redundant data, and designs a set of techniques to accelerate inline deduplication in a storage apparatus, e.g. SSD.

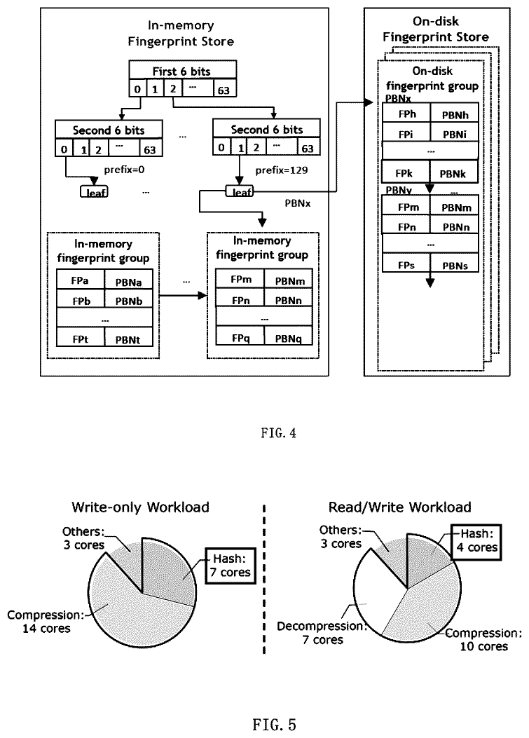

FIG. 4 illustrates an example of SmartDedup (smart deduplication) two-stage fingerprint storage architecture, which uses common fingerprint storage in-memory and on-disk to minimize memory overhead.

Data deduplication may reduce data duplicate writes, avoid frequent garbage collection and extend the life of SSDs, and thus reducing the cost of use for customers. However, data deduplication techniques, such as the ones described above may have the following problems:

First, fingerprint computation brings significant CPU computation overhead (>=16%). FIG. 5 illustrates an example of fingerprint computation overhead of the data deduplication. Referring to FIG. 5, for example, when using a hash value as the fingerprint, left side is a workload of a write only case, where hash computation occupies 7 cores with a total of 24 cores, and CPU computation overhead is about 29.2%. Right side is a workload of a read/write case, where the hash computation occupies 4 cores with also a total of 24 cores, and the CPU computation overhead is about 16.7%.

Second, fingerprint storage brings significant DRAM overhead. Taking a 4T SSD as an example, if each 4K page generates a SHA-1 fingerprint (160 bits), all the fingerprint data may require at least 20 GB of storage space, which may offset the benefits of the data deduplication due to cost considerations.

Third, if it is considered that fingerprint data is stored by flash memory in combination with DRAM, with only some fingerprint data frequently accessed being cached in the DRAM, overhead of loading fingerprint data from the flash memory is high when the cache is not hit.

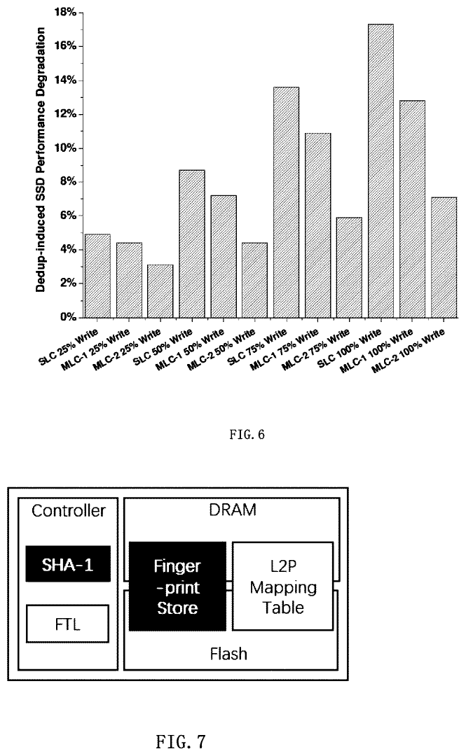

Fourth, data deduplication may have a negative impact on normal data reading and writing. FIG. 6 illustrates an impact of an example of data deduplication on performance of a storage apparatus. Here, as an example, the storage apparatus is an SSD, for example, in the case of SLC (Single-Level Cell) with 25% write load, performance degradation of the SSD due to the data deduplication is about 5%, in the case of MLC (Multi-Level Cell)-2 with 25% write load, the performance degradation of the SSD due to the data deduplication is about 3%, and as the write load increases, the SSD performance degradation becomes more significant.

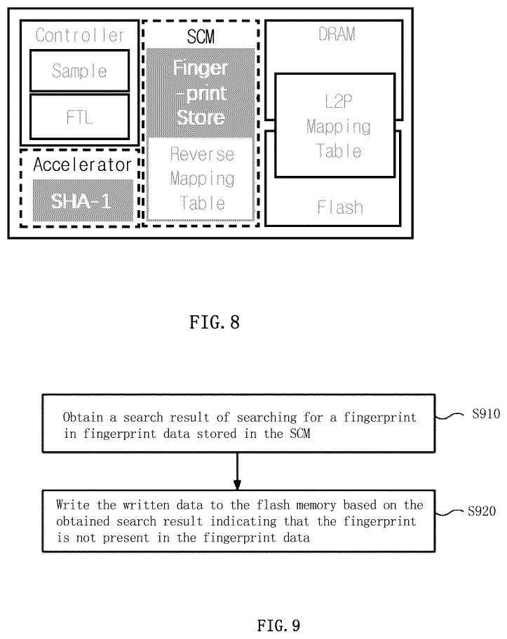

To address the above problems, the disclosure provides a method for data deduplication of a storage apparatus and the storage apparatus. As to the first problem described above, the disclosure utilizes a hardware acceleration module set up inside the storage apparatus to take on the computational tasks (e.g., generating fingerprints and searching for the fingerprints) during the data deduplication to avoid bringing the computational overhead to the main control chip (e.g., CPU of a host or a controller in the storage apparatus). As to the second and the third problems described above, the disclosure introduces a storage class memory SCM module to store the fingerprint data, on one hand, read and write performance of the SCM has the same order of magnitude as the DRAM, and on the other hand, the SCM is lower in price compared to the DRAM. As to the fourth problem described above, the disclosure provides a reverse mapping table and a sampling module, wherein the reverse mapping table is stored in the SCM and used to store mappings of a single physical address to a plurality of logical addresses, instead of storing this mapping information in the out-of-band space of the flash memory, thus avoiding the need to frequently update the flash memory during the data deduplication procedure. And the sampling module samples a current controller workload and a data duplication rate, and the deduplication mechanism is enabled if the sampled controller workload is low and the data duplication rate is high, thus improving or maximizing the benefit of data deduplication. Hereinafter, the method for data deduplication of the storage apparatus and the storage apparatus according to the disclosure are described specifically with reference to FIGS. 8 to 20.

FIG. 7 illustrates a block diagram of example of data deduplication methods. FIG. 8 illustrates a block diagram of internal modules of a storage apparatus according to example embodiments. Referring to FIG. 7, an interior of the storage apparatus using an example data deduplication method includes a controller, a DRAM and a flash memory, wherein the controller performs the FTL and computational tasks in the data deduplication procedure (e.g., generating fingerprints and searching for the fingerprints, with the fingerprints being, for example, SHA-1) and both fingerprint data and a logical-to-physical L2P mapping table may be stored in both the DRAM and the flash memory. Here, the illustrated internal block diagram of the storage apparatus for the data deduplication method is for example only, the computational tasks in the data deduplication procedure may also be performed by CPU of a host, and the disclosure is not limited thereto.

With reference to FIGS. 7 and 8, new hardware modules (indicated by dashed lines) added to the interior of the storage apparatus (e.g. SSD) of the disclosure includes an SCM and a hardware acceleration module (e.g. a hardware accelerator), wherein the fingerprint data and a reverse mapping table are stored in the SCM. The SCM which is a new type of storage medium is non-volatile, has short access latency and is low in price. There are a variety of current SCM media technologies, including PCM (Phase Change Memory). And the hardware acceleration module takes on the computational tasks in the data deduplication procedure, which may include generating the fingerprints and/or searching for the fingerprints. A new data structure and a software module also added to the interior of the storage apparatus of the disclosure are the reverse mapping table and a sampling module respectively, where the reverse mapping table is stored in the SCM to manage mappings of physical addresses to logical addresses. The operations of the sampling module as the software module may be performed by the controller to sample a controller workload and a data duplication rate, so as to determine whether to enable the data deduplication.

It should be understood that the block diagram of the internal modules of the storage apparatus herein are examples only and the disclosure is not limited thereto.

FIG. 9 illustrates a flowchart of a method for data deduplication of a storage apparatus according to example embodiments.

The storage apparatus may be a novel computing type storage apparatus, the storage apparatus may be, for example, an SSD, and the storage apparatus may comprise a SCM and a flash memory (flash) according to example embodiments.

Referring to FIG. 9, in operation S910, a search result of searching for a fingerprint in fingerprint data stored in the SCM is obtained, wherein the fingerprint may be generated based on written data.

In some example embodiments of the disclosure, the operation of the data deduplication first requires determining whether the write data is duplicate data. The write data may refer to input data of the storage apparatus and may be referred to as “written data” or “incoming write.” For example, the operation of generating the fingerprint of the written data and searching for the fingerprint in the fingerprint data may be performed by CPU of a host or a controller of the storage apparatus, or the operation of generating the fingerprint and searching for the fingerprint as described above may be performed by a hardware acceleration module according to some example embodiments of the disclosure, thereby generating the search result. In some example embodiments of the disclosure, it is determined whether the written data is duplicate data by obtaining the search result of searching for the fingerprint generated by the written data in the fingerprint data. The fingerprint data includes fingerprints of data already stored in the flash memory, and the fingerprint data may be stored and managed in the form of a fingerprint table. If the search result is the fingerprint generated by the written data being present in the fingerprint data, the same data as the written data is already stored in the flash memory, e.g. the written data is the duplicate data, while if the fingerprint is not present in the fingerprint data, the same data as the written data is not stored in the flash memory, e.g. the written data is not the duplicate data. The fingerprint may be, for example, a hash value, but the disclosure is not limited thereto. In the case that the fingerprint is the hash value, the fingerprint data may be stored and managed in the form of a hash table.

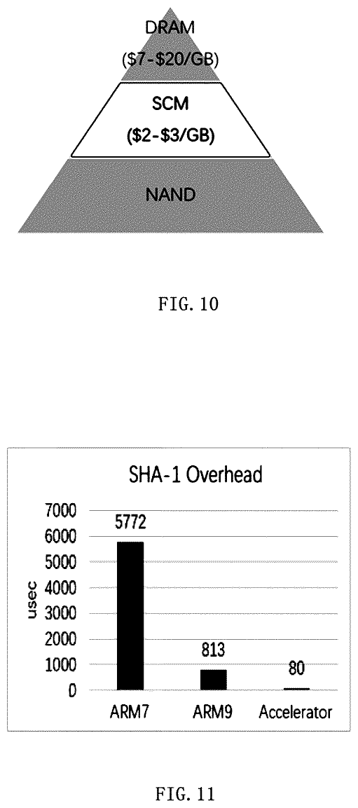

In some example embodiments of the disclosure, the SCM is introduced in the storage apparatus to store the fingerprint data, and SCM which is a new type of storage medium is non-volatile, has short access latency and is low in price. FIG. 10 illustrates a comparison of different storage apparatuses according to example embodiments. Referring to FIG. 10, the DRAM at the top of a pyramid may have a higher price per capacity (e.g., $7-$20/GB) and the best read/write performance, while the SCM in the middle of the pyramid may have the middle range of price per capacity (e.g., $2-$3/GB) and read/write performance of the same order of magnitude as the DRAM but slightly worse than the DRAM, and the NAND at the bottom of the pyramid has the worst read/write performance despite its low price. By introducing the SCM to store the fingerprint data, it is possible to obtain better read/write performance and at the same time, SCM is also relatively inexpensive.

According to example embodiments of the disclosure, the storage apparatus may further include a hardware acceleration module, the fingerprint of the written data is generated by the hardware acceleration module and the fingerprint is searched for by the hardware acceleration module in the fingerprint data stored in the SCM.

In example embodiments of the disclosure, the hardware acceleration module (e.g., a hardware accelerator) may be introduced into the storage apparatus, and the hardware acceleration module may generate fingerprints and search for the fingerprints. FIG. 11 illustrates overhead of different processors for generating fingerprints according to example embodiments. Here, SHA-1 is calculated as an example, time to calculate SHA-1 (both generating SHA-1 and searching for the SHA-1) is 5772, 813 and 80 microseconds (μsec) for an ARM7, an ARM9 and the hardware accelerator respectively. By introducing the hardware accelerator module to take on the computational tasks in the data deduplication procedure, computational overhead to the main control chip (e.g., CPU of the host or the controller in the storage apparatus) is avoided and computational efficiency is improved.

According to example embodiments of the disclosure, the storage apparatus may further include a sampling module, the sampling module is controlled to sample a controller workload and to sample a data duplication rate. In the case that the controller workload obtained by sampling is less than a first threshold and the data duplication rate is greater than a preset data duplication rate, an operation of obtaining the search result of searching for the fingerprint generated by the written data in the fingerprint data stored in the SCM is performed, wherein the preset data duplication rate is calculated as a ratio between a sum of time to generate the fingerprint and time to search for the fingerprint and time to program data into the flash memory.

In example embodiments of the disclosure, the sampling module (e.g., the software module) may periodically sample the controller workload, and if the workload is too high, which indicates that the storage apparatus is busy with read and write requests, in such a case, the data deduplication should be disabled. The sampling module may determine whether the data deduplication should be enabled by estimating the data duplication rate of the batch of data currently being written, and depending on how high the data duplication rate is. The data deduplication operation in the storage apparatus is enabled only if the workload of the controller is low, e.g. less than the first threshold, and the data duplication rate satisfies a given threshold, e.g. greater than the preset data duplication rate. The first threshold here may be an empirical value or a default value, and the preset data duplication rate is discussed below.

In a write operation without the data deduplication, the write operation includes two processing steps, namely programming data into the flash memory and updating mapping information (e.g., mapping table). The write latency without the data deduplication is calculated as follows:

$${Write}_{latency} = {FM}_{program} + {MAP}_{manageg} \qquad ( 1 )$$

Wherein FM_{program} is the time to program the data into the flash memory and MAP_{manage} is the time to update the mapping information.

In a write operation with the data deduplication, the operation for duplicate data includes three steps, namely generating a fingerprint, searching for the fingerprint and updating mapping information, while the operation for non-duplicate data includes four steps, namely generating the fingerprint, searching for the fingerprint, updating the mapping information and programming the data into the flash memory. The write latency with the data deduplication is calculated as follows:

$${Write}_{latency} = ( {FP}_{generate} + {FP}_{manage} + {MAP}_{manage} ) \times {DUP}_{ratio} + ( {FP}_{generate} + {FP}_{manage} + {MAP}_{manage} + {FM}_{program} ) \times ( 1 - {DUP}_{ratio} ) \qquad ( 2 )$$

Wherein FP_{generator} is the time to generate the fingerprint, FP_{manage} is the time to search for the fingerprint, DUPᵣₐₜₑ is ratio of the duplicate data to total written data, e.g. the data duplication rate, and similarly, M_{program} is the time to program the data into the flash memory and MAP_{manage} is the time to update the mapping information.

For data deduplication to have a positive benefit, the write latency with the data deduplication (e.g. Write_{latency} in Equation (2)) is less than the write latency without the data deduplication (e.g. Write_{latency} in Equation (1)), the equation is obtained from Equations (1) and (2) above as follows:

$${DUP}_{ratio} > \frac{{FP}_{generate} + {FP}_{manage}}{{FM}_{program}} \qquad ( 3 )$$

Equation (3) shows that the data deduplication provides the positive benefit as long as the DUPᵣₐₜᵢₒ is greater than

$$\frac{{FP}_{generate} + {FP}_{manage}}{{FM}_{program}} ,$$

wherein

$$\frac{{FP}_{generate} + {FP}_{manage}}{{FM}_{program}}$$

is the preset data duplication rate, e.g., the ratio between the sum of the time to generate the fingerprint and the time to find the fingerprint and the time to program the data into the flash memory.

In example embodiments of the disclosure, in the case that the data duplication rate is greater than the preset data duplication rate, at this time, the data duplication rate DUPᵣₐₜₑ satisfies equation (3), that is, the data duplication rate satisfies the condition that enables the data deduplication. Since the hardware acceleration module is used to handle the computational tasks (generating fingerprints and searching for the fingerprints) and the SCM is used to store the fingerprint data, both the FP generate and the FP_{manage} are significantly reduced, and thus, it may still be beneficial for performing the data deduplication with a small data duplication rate (DUPᵣₐₜᵢₒ).

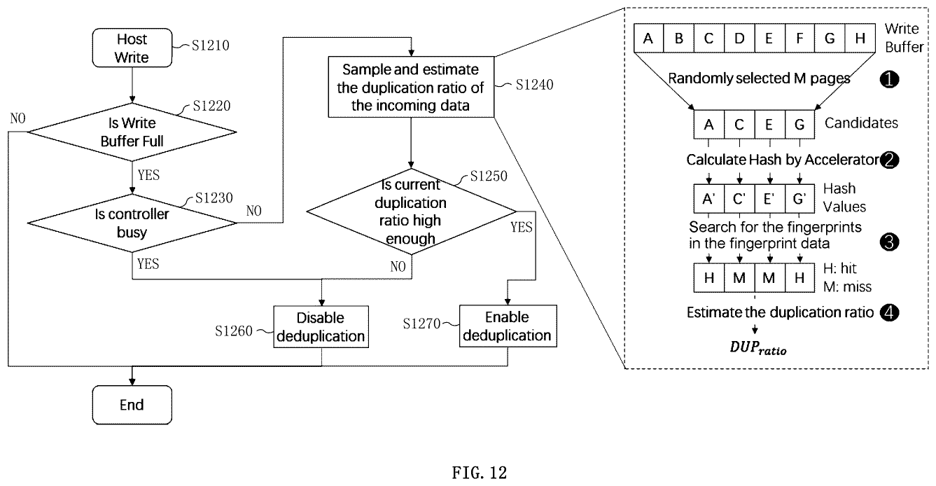

According to example embodiments of the disclosure, the sampling of the data duplication rate may include: randomly selecting a specified number of pages of data in a write cache, wherein the specified number of pages of data is used to generate a corresponding specified number of fingerprints, obtaining search results of searching for the specified number of the fingerprints in the fingerprint data stored in the SCM, and calculating the data duplication rate based on the search results of the specified number of the fingerprints. FIG. 12 illustrates a flowchart of a data deduplication strategy according to example embodiments. Referring to FIG. 12, in operation S1210, a host (e.g., a CPU) begins a write operation. In operation S1220, it is determined whether the write cache is full, where the write cache may be a cache in the DRAM, if the write cache is full (“YES”), it proceeds to operation S1230 and the flow ends if the write cache is not full (“NO”).

In operation S1230, it is determined whether the controller is busy. The sampling module may collect the controller workload as a judgement criterion to determine whether the controller is busy or not. In the case that the controller is busy (“YES”), indicating the storage apparatus is busy with read and write requests, it proceeds to operation S1260. In operation S1260, the data deduplication is disabled. In the case that the controller is not busy (“NO”), it proceeds to operation S1240.

In operation S1240, a duplication rate of incoming data is sampled and estimated. In example embodiments of the disclosure, operation S1240 includes four sub-operations: in sub-operation 1, M pages of data are randomly selected, with M being the specified number (e.g., 4), wherein the data in the write cache is stored in the form of the page (e.g., including a total of 8 pages from A to H) and the specified number of pages of data may be randomly selected as candidates used for calculating the data duplication rate, e.g., the sampling module may randomly select a total of 4 pages (A, C, E and G) as candidates. In sub-operation 2, a fingerprint corresponding to each page is generated (e.g., a hash value is calculated), where the specified number of pages of data are used to generate the corresponding specified number of fingerprints, with pages A, C, E and G corresponding to fingerprints A′, C′, E′ and G′ respectively. In sub-operation 3, the fingerprints are searched for in the fingerprint data to generate the search results, which are the result of searching for the specified number of fingerprints respectively in the fingerprint data. The fingerprints A′, C′, E′ and G′ may be searched for respectively in the fingerprint data and the search results are generated including the presence or absence of the fingerprints. In sub-operation 4, the data duplication rate is estimated, here, the data duplication rate may be calculated based on the search results of the specified number of fingerprints. If a search result is a fingerprint being present in the fingerprint data, data corresponding to the fingerprint is considered to be duplicate data, while if the search result is the fingerprint not being present in the fingerprint data, the data corresponding to the fingerprint is considered not to be the duplicate data, so that the data duplication rate may be calculated. For example, if the search results of fingerprints A′ and G′ are present (H means hit) and the search results of fingerprints C′ and E′ are not present (M means miss), then A and G are the duplicate data and C and E are not the duplicate data. The duplication rate is 50% at this time. Among the above four sub-operations, sub-operations 1 and 2 may be implemented by the sampling module and sub-operations 2 and 3 (e.g., operations of generating fingerprints and searching for the fingerprints) may be performed by the hardware acceleration module (e.g., a hardware accelerator). Here, the hardware acceleration module may acquire the specified number of pages (e.g., M pages) of data randomly selected by the sampling module, and the sampling module may acquire the search results of the specified number of fingerprints generated by the hardware acceleration module. The sampling module may be a software module controlled by the controller or the operations of the sampling module as a software module may be performed by the controller.

In operation S1250, it is determined whether the current data duplication rate is high enough, e.g. whether the data duplication rate is greater than the preset data duplication rate. In the case of a low data duplication rate (“NO”), turning on the data deduplication does not bring a positive benefit to the storage apparatus, and thus it proceeds to operation S1260, in which the data deduplication is disabled. In the case of a high data duplication rate (“YES”), it proceeds to operation S1270. In operation S1270, the data deduplication is enabled.

It should be understood that the operations or sub-operations in the flowchart of the data deduplication strategy herein are examples only and the disclosure is not limited thereto, for example, order of the operations may be changed.

Returning to FIG. 9, in operation S920, the written data is written to the flash memory based on the obtained search result indicating that the fingerprint is not present in the fingerprint data.

According to example embodiments of the disclosure, the fingerprint may be written to the fingerprint data stored in the SCM in the case that the search result is the fingerprint not being present in the fingerprint data. Mapping information of a logical address to a physical address is inserted into a logical-physical (L2P) mapping table, wherein the physical address is an address of the written data in the flash memory in the case that the search result is the fingerprint not being present in the fingerprint data, and the physical address is an address of a first data already stored in the flash memory in the case that the search result is the fingerprint being present in the fingerprint data, wherein the first data has the same fingerprint as the written data.

In example embodiments of the disclosure, in the case that the search result is the fingerprint not being present in the fingerprint data, the written data corresponding to the fingerprint is not duplicate data, the written data is written to the flash memory and the logical-physical mapping table (the L2P mapping table) needs to be updated. In a computer with address translation, an address (operand) given by an access instruction is called the logical address, or relative address, and an actual memory address stored in memory is called the physical address. The L2P mapping table stores information about the mapping of the logical address to the physical address, e.g., it characterizes the mapping relationship between LBA (Logical Block Address) and PBA (Physical Block Address), and the L2P table is a dynamically changing table. After the written data is written to the flash memory, the physical address is the address of the written data in the flash memory, and the mapping information of the logical address to the physical address is inserted into the logical-physical (L2P) mapping table.

In example embodiments of the disclosure, in the case that the search result is the fingerprint being present in the fingerprint data, the written data corresponding to the fingerprint is the duplicate data of the first data already stored in the flash memory, the first data has the same fingerprint as the written data and the address (physical address) of the first data in the flash memory may be stored in the fingerprint data corresponding to this fingerprint. In the case that the search result is the fingerprint being present in the fingerprint data, only the L2P mapping table needs to be updated, that is, the mapping information of the logical address to the physical address is inserted into the logical-physical (L2P) mapping table, at this time, the physical address is the address of the first data already stored in the flash memory. Thus, in the case that the written data is the duplicate data, the operation of writing the written data to the flash memory is reduced.

According to example embodiments of the disclosure, reverse mapping information of the physical address to the logical address is inserted into a reverse mapping table, wherein the reverse mapping table is stored in the SCM.

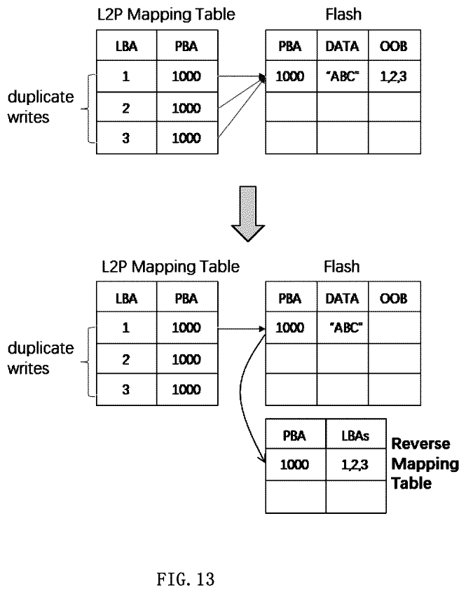

FIG. 13 illustrates schematic diagrams of function of a reverse mapping table according to example embodiments. Referring to FIG. 13, in an example data deduplication method, an out of band (OOB) area of the flash memory needs to be updated repeatedly to record the mapping information. For example, in the L2P mapping table, the duplicate data with LBAs 1, 2 and 3 all correspond to the same PBA 1000. For the write operation of the duplicate data, every time the L2P mapping table is updated, the corresponding LBA needs to be updated and written into the OOB area of the flash memory. For example, when writing the duplicate data with LBA 3, LBA (3)-PBA (1000) is inserted into the L2P mapping table, the LBA also needs to be written into the OOB area of the flash memory. The purpose of writing the LBA of the duplicate data into the OOB area is that, for example, when the duplicate data in the flash memory is moved (e.g., garbage collection), the PBA of the duplicate data is changed, the L2P mapping table needs to be modified correspondingly, and if the LBA of the duplicate data is not written into the OOB area, the PBA corresponding to which LBA in the L2P mapping table need to be updated is not known. Although, in the case that the written data is duplicate data, the operation of writing the written data to the flash memory is reduced, the OOB area of flash memory (the LBA of the duplicate data is written) is still updated, thus increasing the overhead of the data deduplication operation.

In example embodiments of the disclosure, the reverse mapping table is introduced to convert the update of the OOB area in the flash memory in the data deduplication method to the update of the reverse mapping table, and the reverse mapping table is stored in the SCM. With continued reference to FIG. 13, after the introduction of the reverse mapping table, the reverse mapping table includes mappings of a single PBA to a plurality of LBAs. For the write operation of duplicate data, every time the L2P mapping table is updated, only relationship between PBA and LBA (P2L) needs to be written into the reverse mapping table. For example, when writing the duplicate data with LBA 3, LBA (3)-PBA (1000) is inserted into the L2P mapping table, PBA (1000)-LAB (3) is also inserted into the reverse mapping table. Moreover, even if the duplicate data in the flash memory is moved, the reverse mapping table may be used to know the PBA corresponding to which LBA in the L2P mapping table need to be updated. Since the SCM has better read and write performance than the flash memory, the overhead of updating the reverse mapping table is small and the efficiency of data deduplication is improved.

It should be understood that the values of the LBAs, PBAs and data in the reverse mapping table herein are examples only and the disclosure is not limited thereto.

In the method for the data deduplication of the storage apparatus as described in the above example embodiments, the introduction of the SCM for storing the fingerprint data enables better read and write performance while avoiding additional overhead to the DRAM and the SCM is relatively inexpensive. The introduction of the hardware acceleration module to take on the computational tasks of the data deduplication procedure avoids the computational overhead to the main control chip. The sampling module is used to sample the current controller workload and the data duplication rate, and the deduplication mechanism is enabled only when the sampled controller workload is low and the data duplication rate is high, thus improving or maximizing the benefits of the data deduplication. The reverse mapping table is used to store mappings of a single physical address to a plurality of logical addresses, and this reverse mapping table is stored in the SCM, which avoids the need to frequently update the flash memory during the data deduplication procedure and improves efficiency of the data deduplication.

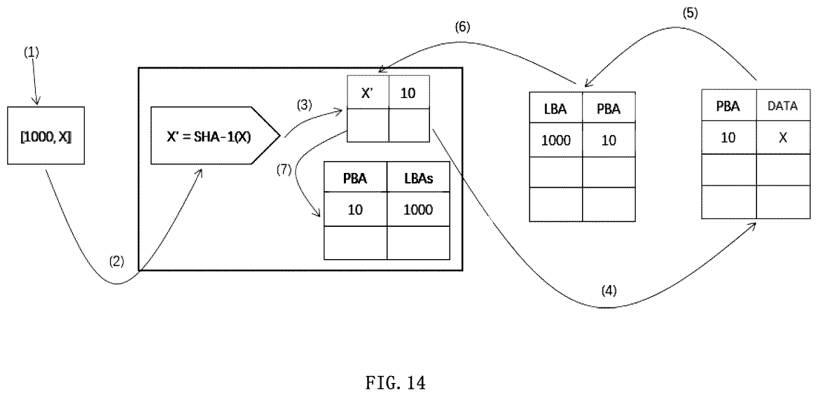

FIG. 14 illustrates a flowchart for processing of writing non-duplicate data X according to example embodiments. Referring to FIG. 14, the operation of writing non-duplicate data X includes: in operation (1), the data X is written, the size of the data volume of X may be, for example, the size of a flash page (e.g. 512 bytes), wherein LBA is 1000. In operation (2), a fingerprint of the data X is generated, e.g. X′=SHA-1 (X). In operation (3), the fingerprint is searched for in a fingerprint table to find whether it is already present. Here, the fingerprint table stored in the SCM is the form in which the fingerprint data is stored and managed, and contents of the fingerprint table include the fingerprint data. The search result of the fingerprint is the fingerprint X′ not being present in the fingerprint table, then X is not duplicate data. Here, operation (2) and operation (3) may be performed by the hardware acceleration module. Based on the obtained fingerprint search result, in operation (4), the data X is written to the flash memory, wherein the data X has a PBA of 10. In operation (5), a line of mapping information is inserted in the L2P mapping table, e.g. LBA (1000)-PBA (10). In operation (6), the fingerprint X′ of X is inserted in the fingerprint table and the PBA of X (10) is also stored in the fingerprint table. In operation (7), P2L reverse mapping information, e.g. PBA (10)-LBA (1000), is inserted in the reverse mapping table, which is stored in the SCM.

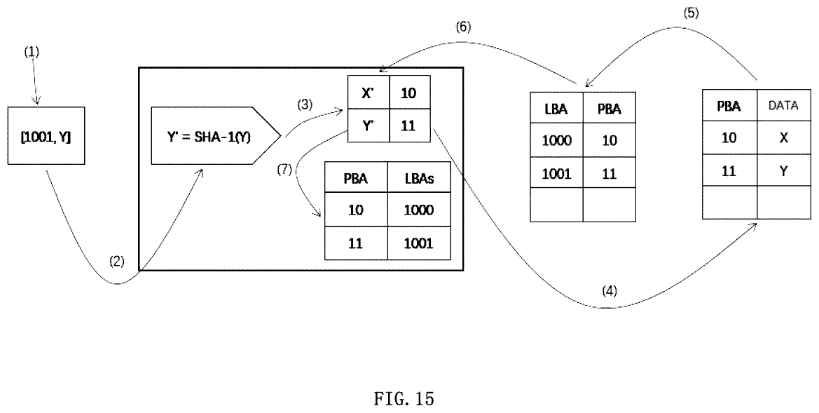

FIG. 15 illustrates a flowchart of processing of writing non-duplicate data Y according to example embodiments. Referring to FIG. 15, the operation of writing non-duplicate data Y in the case that the non-duplicate data X has already been written, includes: in operation (1), the data Y is written, the size of the data volume of Y may be, for example, the size of a flash page (e.g. 512 bytes), wherein LBA is 1001. In operation (2), a fingerprint of the data Y is generated, e.g. Y′=SHA-1 (Y). In operation (3), the fingerprint is searched for in a fingerprint table to find whether it is already present. Here, the fingerprint table stored in the SCM is the form in which the fingerprint data is stored and managed, and contents of the fingerprint table include the fingerprint data. The search result of the fingerprint is the fingerprint Y′ not being present in the fingerprint table, then Y is not duplicate data. Here, operation (2) and operation (3) may be performed by the hardware acceleration module. Based on the obtained fingerprint search result, in operation (4), the data Y is written to the flash memory, where the data Y has a PBA of 11. In operation (5), a line of mapping information is inserted in the L2P mapping table, e.g. LBA (1001)-PBA (11). In operation (6), the fingerprint Y′ of Y is inserted in the fingerprint table and the PBA of Y (11) is also stored in the fingerprint table. In operation (7), P2L reverse mapping information, e.g. PBA (11)-LBA (1001), is inserted in the reverse mapping table, which is stored in the SCM.

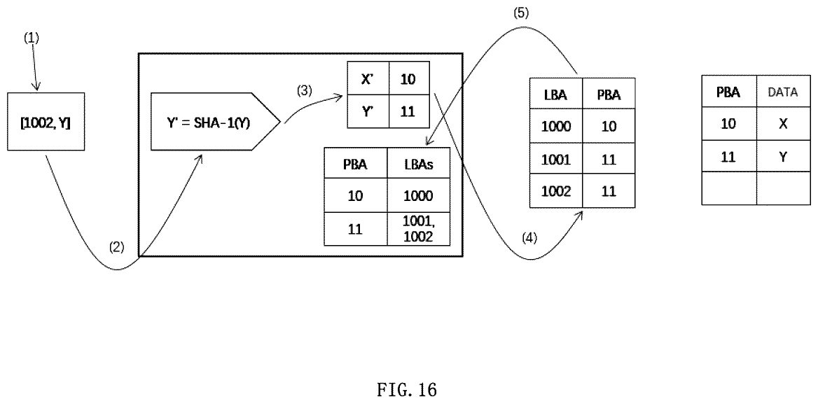

FIG. 16 illustrates a flowchart of processing of writing duplicate data Y according to example embodiments. Referring to FIG. 16, the operation of writing duplicate data Y in the case that the non-duplicate data X and Y have already been written, includes: in operation (1), the data Y is written, the size of the data volume of Y may be, for example, the size of a flash page (e.g., 512 bytes), wherein LBA is 1002. In operation (2), a fingerprint of the data Y is generated, e.g., Y′=SHA-1 (Y). In operation (3), the fingerprint is searched for in the fingerprint table to find whether it is already present. Here, the fingerprint table stored in the SCM is the form in which the fingerprint data is stored and managed, and contents of the fingerprint table include the fingerprint data. The search result of the fingerprint is the fingerprint Y′ being present in the fingerprint table, then Y is the duplicate data. Here, operation (2) and operation (3) may be performed by the hardware acceleration module. Based on the obtained fingerprint search result, in operation (4), a line of mapping information is inserted in the L2P mapping table, e.g. LBA (1002)-PBA (11). Since the fingerprint table also stores PBA (11) for the data corresponding to fingerprint Y′, the address PBA (11) of Y already stored in the flash memory may be obtained. In operation (5), P2L reverse mapping information is inserted in the reverse mapping table, e.g. PBA (11)-LBA (1002), and the reverse mapping table is stored in the SCM.

It should be understood that the values of the LBAs, PBAs and data in FIGS. 14-16 are examples only and the disclosure is not limited thereto.

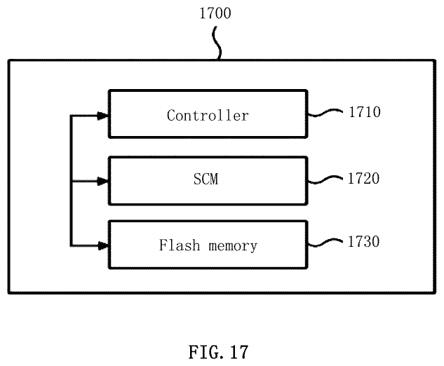

FIG. 17 illustrates a schematic diagram of a storage apparatus according to example embodiments. The storage apparatus may be a novel computing type storage apparatus, and the storage apparatus may be, for example, an SSD.

Referring to FIG. 17, the storage apparatus 1700 includes a controller 1710, a storage class memory (SCM) 1720, and a flash memory 1730, wherein the SCM 1720 stores fingerprint data and the controller 1710 obtains a search result of searching for a fingerprint generated by written data in the fingerprint data, and controls to write the written data to the flash memory 1730 in the case that the search result is the fingerprint not present in the fingerprint data.

According to example embodiments of the disclosure, the storage apparatus 1700 may also include a sampling module 1740 (not shown), and the controller 1710 may control the sampling module to sample a controller workload and to sample a data duplication rate, wherein in the case that the controller workload obtained by sampling is less than a first threshold and the data duplication rate is greater than a preset data duplication rate, the controller 1710 may obtain the search result of searching for the fingerprint generated by the written data in the fingerprint data, wherein the preset data duplication rate is calculated as a ratio between a sum of time to generate the fingerprint and time to search for the fingerprint and time to program data into the flash memory 1730.

According to example embodiments of the disclosure, the sampling module 1740 may randomly select a specified number of pages of data in a write cache, wherein the specified number of pages of data is used to generate a corresponding specified number of fingerprints. The sampling module 1740 may obtain search results of searching for the specified number of the fingerprints in the fingerprint data, and may calculate the data duplication rate based on the search results of the specified number of the fingerprints.

According to example embodiments of the disclosure, the SCM 1720 may also store the fingerprint data including the fingerprints in the case that the search result is the fingerprint not being present in the fingerprint data.

According to example embodiments of the disclosure, the controller 1710 may further control to insert the mapping information of a logical address to a physical address into a logical-physical (L2P) mapping table, wherein the physical address is an address of the written data in the flash memory 1730 in the case that the search result is the fingerprint not being present in the fingerprint data, and the physical address is an address of the first data already stored in the flash memory 1730 in the case that the search result is the fingerprint being present in the fingerprint data, wherein the first data has the same fingerprint as the written data.

According to example embodiments of the disclosure, the SCM 1720 may further store a reverse mapping table, and the controller 1710 may further control to insert the reverse mapping information of the physical address to the logical address into the reverse mapping table.

According to example embodiments of the disclosure, the storage apparatus 1700 may further includes a hardware acceleration module 1750 (not shown), the hardware acceleration module 1750 may generate the fingerprint of the written data and search for the fingerprint in the fingerprint data.

In the storage apparatus in the above example embodiments, the introduction of the SCM for storing the fingerprint data enables better read and write performance while avoiding additional overhead to the DRAM and the SCM is relatively inexpensive. The introduction of the hardware acceleration module to take on the computational tasks of the data deduplication procedure avoids the computational overhead to the main control chip. The sampling module is used to sample the current controller workload and the data duplication rate, and the data deduplication mechanism is enabled only when the sampled controller workload is low and the data duplication rate is high, thus improving or maximizing the benefits of the data deduplication. The reverse mapping table is used to store mappings of a single physical address to a plurality of logical addresses, and this reverse mapping table is stored in the SCM, which avoids the need to frequently update the flash memory during the data deduplication procedure and improves efficiency of the data deduplication.

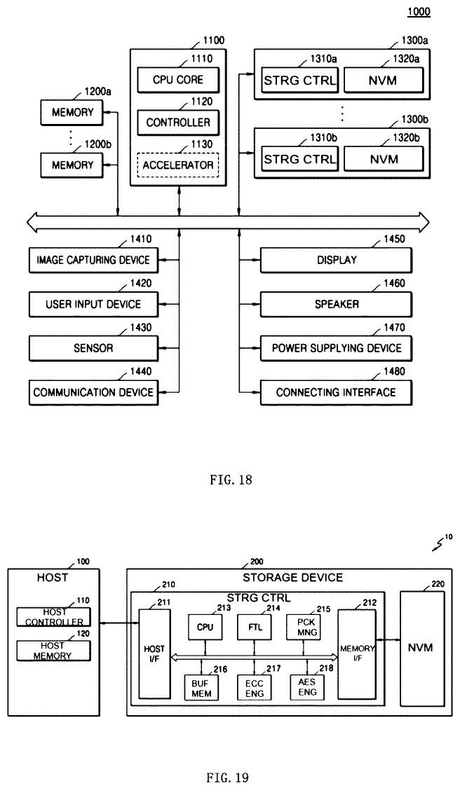

FIG. 18 is a diagram of a system 1000 to which a storage device is applied, according to example embodiments.

The system 1000 of FIG. 18 may basically be a mobile system, such as a portable communication terminal (e.g., a mobile phone), a smartphone, a tablet personal computer (PC), a wearable device, a healthcare device, or an Internet of things (IoT) device. However, the system 1000 of FIG. 18 is not necessarily limited to the mobile system and may be a PC, a laptop computer, a server, a media player, or an automotive device (e.g., a navigation device).

Referring to FIG. 18, the system 1000 may include a main processor 1100, memories (e.g., 1200a and 1200b), and storage devices (e.g., 1300a and 1300b). The system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, for example, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some example embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. The storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to example embodiments of the disclosure, a system (e.g., 1000), to which a storage apparatus is applied, is provided, the system includes a main processor (e.g., 1100); a memory (e.g., 1200a and 1200b); and the storage apparatus (e.g., 1300a and 1300b), wherein the storage apparatus is configured to perform the method for data deduplication of the storage apparatus as described above.

FIG. 19 is a block diagram of a host storage system 10 according to example embodiments.

The host storage system 10 may include a host 100 and a storage device 200. Further, the storage device 200 may include a storage controller 210 and an NVM 220. According to some example embodiments, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to some example embodiments, the host controller 110 and the host memory 120 may be implemented as separate semiconductor chips. Alternatively, in some example embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for reducing or preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. The buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. For example, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to example embodiments of the disclosure, a host storage system (e.g., 10) is provided, the host storage system includes a host (e.g., 100); and a storage apparatus (200), wherein the storage apparatus is configured to perform the method for data deduplication of the storage apparatus as described above.

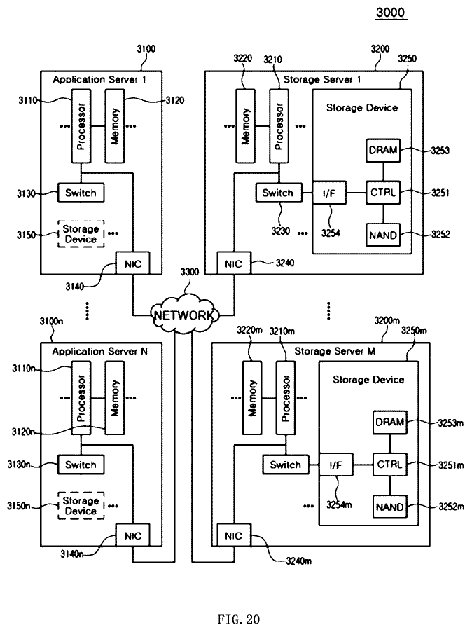

FIG. 20 is a diagram of a data center 3000 to which a memory device is applied, according to example embodiments.

### Platform Portion—Server (Application/Storage)

Referring to FIG. 20, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to example embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 3210 and memories 3220 included in the storage server 3200 may be variously selected. In some example embodiments, the processor 3210 and the memory 3220 may provide a processor-memory pair. In some example embodiments, the number of processors 3210 may be different from the number of memories 3220. The processor 3210 may include a single-core processor or a multi-core processor. The above description of the storage server 3200 may be similarly applied to the application server 3100. In some example embodiments, the application server 3100 may not include a storage device 3150. The storage server 3200 may include at least one storage device 3250. The number of storage devices 3250 included in the storage server 3200 may be variously selected according to example embodiments.

### Platform Portion—Network

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In some example embodiments, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In other example embodiments, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Organic Relationship—Interface Structure/Type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In example embodiments, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In some example embodiments, the NIC 3240 may be integrated with at least one of the processor 3210, the switch 3230, and the storage device 3250.

### Organic Relationship—Interface Operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### Product Portion—SSD Basic Operation

The controller 3251 may control all operations of the storage device 3250. In some example embodiments, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to example embodiments of the disclosure, a data center system (e.g., 3000) is provided, the data center system includes a plurality of application servers (3100 to 3100n); and a plurality of storage servers (e.g., 3200 to 3200m), wherein each storage server includes a storage apparatus, wherein the storage apparatus is configured to perform the method for data deduplication of the storage apparatus as described above.

According to example embodiments of the disclosure, a computer-readable storage medium may also be provided, wherein a computer program is stored thereon, the program when executed may implement the method for data deduplication of the storage apparatus as described above. Examples of computer-readable storage media include read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid state drive (SSD), card-based memory (such as, e.g., multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as, for example, a terminal, client, host, agent, server, etc. In one example, the computer program and any associated data, data files and/or data structures are distributed on a networked computer system such that the computer program and any associated data, data files and/or data structures are stored, accessed, and/or executed in a distributed manner by one or more processors or computers.

One or more elements described above may be implemented using processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, a programmable logic unit, a microprocessor, application-specific integrated circuit (ASIC), etc. The processing circuitry may include a memory such as a volatile memory device (e.g., SRAM, DRAM, and SDRAM) and/or a non-volatile memory (e.g., flash memory device, phase-change memory, ferroelectric memory device).

The NPU may, for example, have a structure that is trainable, e.g., with training data, such as an artificial neural network, a decision tree, a support vector machine, a Bayesian network, a genetic algorithm, and/or the like. Non-limiting examples of the trainable structure may include a convolution neural network (CNN), a generative adversarial network (GAN), an artificial neural network (ANN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

According to the method for data deduplication of a storage apparatus and the storage apparatus of the disclosure, the introduction of the SCM for storing the fingerprint data enables better read and write performance while avoiding additional overhead to the DRAM and the SCM is relatively inexpensive. The introduction of the hardware acceleration module to take on the computational tasks of the data deduplication procedure avoids the computational overhead to the main control chip. The sampling module is used to sample the current controller workload and the data duplication rate, and the deduplication mechanism is enabled only when the sampled controller workload is low and the data duplication rate is high, thus improving or maximizing the benefits of data deduplication. The reverse mapping table is used to store mappings of a single physical address to a plurality of logical addresses, and this reverse mapping table is stored in the SCM, which avoids the need to frequently update the flash memory during the data deduplication procedure and improves efficiency of the data deduplication.

While the present disclosure has been particularly shown and described with reference to example embodiments thereof, it will be understood by those of ordinary skill in the art that various changes in form and detail may be made therein without departing from the spirit and scope of the present disclosure as defined by the following claims.

What is claimed is:

1. A method for data deduplication of a storage apparatus, wherein the storage apparatus comprises a storage class memory (SCM) and a flash memory, the method comprising:
obtaining a search result of searching for a fingerprint in fingerprint data stored in the SCM, the fingerprint being generated based on written data, and the written data being input data received by the storage apparatus; and
writing the written data to the flash memory based on the obtained search result indicating that the fingerprint is not present in the fingerprint data.

2. The method of claim 1, further comprising:
sampling a controller workload and a data duplication rate,
wherein the search result of searching for the fingerprint generated based on the written data is obtained based on the sampled controller workload being less than a first threshold and the sampled data duplication rate being greater than a preset data duplication rate.

3. The method of claim 2, wherein the sampling of the data duplication rate comprises:
selecting, randomly, a number of pages of data in a write cache;
generating a corresponding number of fingerprints based on the number of randomly selected pages of data;
obtaining search results of searching for the corresponding number of fingerprints based on the number of randomly selected pages of data in the fingerprint data stored in the SCM; and
calculating the data duplication rate based on the search results of the corresponding number of the fingerprints.

4. The method of claim 2, wherein the preset data duplication rate is calculated based on a ratio between a sum of time to generate the fingerprint generated based on the written data and time to search for the fingerprint generated based on the written data and time to program data into the flash memory.

5. The method of claim 2, wherein the storage apparatus further comprises a sampling module configured to sample the controller workload and the data duplication rate.

6. The method of claim 1, wherein the method further comprises:
writing the fingerprint generated based on the written data into the fingerprint data based on the search result indicating that the fingerprint generated based on the written data is not present in the fingerprint data.

7. The method of claim 1, wherein the method further comprises:
inserting mapping information of a logical address to a physical address into a logical-physical (L2P) mapping table,
wherein the physical address is an address of the written data in the flash memory based on the search result indicating that the fingerprint generated based on the written data is not present in the fingerprint data,
wherein the physical address is an address of a first data stored in the flash memory based on the search result indicating that the fingerprint generated based on the written data is present in the fingerprint data, and the first data having the same fingerprint as the written data.

8. The method of claim 7, wherein the method further comprises:
inserting reverse mapping information of the physical address to the logical address into a reverse mapping table, wherein the reverse mapping table is stored in the SCM.

9. The method of claim 1, wherein the storage apparatus further comprises a hardware acceleration module, the method further comprising:
generating, by the hardware acceleration module, the fingerprint generated based on the written data; and
searching, by the hardware acceleration module, for the fingerprint generated based on the written data in the fingerprint data stored in the SCM.

10. A storage apparatus comprising a controller, a storage class memory (SCM) and a flash memory;
wherein the SCM including fingerprint data, and
wherein the controller is configured to:
obtain a search result of searching for a fingerprint in the fingerprint data in the SCM, the fingerprint being generated based on written data, and the written data being input data received by the storage apparatus; and
write the written data to the flash memory based on the obtained search result indicating that the fingerprint generated based on the written data is not present in the fingerprint data.

11. The storage apparatus of claim 10, further comprising a sampling module configured to sample a controller workload and to sample a data duplication rate,
wherein the controller is configured to obtain the search result of searching for the fingerprint generated based on the written data in the fingerprint data based on the sampled controller workload being less than a first threshold and the sampled data duplication rate being greater than a preset data duplication rate.

12. The storage apparatus of claim 11, wherein the sampling of the data duplication rate comprises:
selecting, randomly, a number of pages of data in a write cache;
generating a corresponding number of fingerprints based on the number of randomly selected pages of data;
obtaining search results of searching for the corresponding number of fingerprints based on the number of randomly selected pages of data in the fingerprint data; and
calculating the data duplication rate based on the search results of the corresponding number of the fingerprints.

13. The storage apparatus of claim 11, wherein the preset data duplication rate is calculated based on a ratio between a sum of time to generate the fingerprint generated based on the written data and time to search for the fingerprint generated based on the written data and time to program data into the flash memory.

14. The storage apparatus of claim 10, wherein the SCM is further configured to store the fingerprint data comprising the fingerprint generated based on the written data in the case that the search result indicating that the fingerprint generated based on the written data is not present in the fingerprint data.

15. The storage apparatus of claim 10, wherein the controller is further configured to:
control insertion of mapping information of a logical address to a physical address into a logical-physical (L2P) mapping table, wherein the physical address is an address of the written data in the flash memory based on the search result indicating that the fingerprint generated based on the written data is not present in the fingerprint data,
wherein the physical address is an address of a first data already stored in the flash memory based on the search result indicating that the fingerprint generated based on the written data is present in the fingerprint data, and the first data having the same fingerprint as the written data.

16. The storage apparatus of claim 15, wherein the SCM is further configured to store a reverse mapping table,
wherein the controller is further configured to: control insertion of the reverse mapping information of the physical address to the logical address into the reverse mapping table.

17. The storage apparatus of claim 10, wherein the storage apparatus further comprises a hardware acceleration module, wherein the hardware acceleration module is configured to: generate the fingerprint generated based on the written data; and search for the fingerprint generated based on the written data in the fingerprint data.

18. A system to which a storage apparatus is applied, comprising:
a main processor;
a main memory; and
the storage apparatus;
wherein the storage apparatus is configured to perform the method for data deduplication of the storage apparatus, the method comprising:
obtaining a search result of searching for a fingerprint in fingerprint data stored in a storage class memory (SCM) in the storage apparatus, the fingerprint being generated based on written data, and the written data being input data received by the storage apparatus; and
writing the written data to a flash memory in the storage apparatus based on the obtained search result indicating that the fingerprint generated based on the written data is not present in the fingerprint data.

19. The system of claim 18, wherein the method further comprising: sampling a controller workload and a data duplication rate,
wherein the search result of searching for the fingerprint generated based on the written data is obtained based on the sampled controller workload being less than a first threshold and the sampled data duplication rate being greater than a preset data duplication rate.

20. The system of claim 18, wherein the storage apparatus comprises a hardware acceleration module,
wherein the method further comprising:
generating, by the hardware acceleration module, the fingerprint generated based on the written data; and
searching, by the hardware acceleration module, for the fingerprint generated based on the written data in the fingerprint data stored in the SCM.
